(19) United States
(12) Patent Application Publication
(10) Pub. No.: US 2006/0267477 A1
(43) Pub. Date: Nov. 30, 2006

(54) Image display device

(76) Inventors: Shigemi Hirasawa, Chiba (JP); Go Saitou, Mobara (JP); Yuichi Inoue, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/370,917

(22) Filed: Mar. 9, 2006

(30) Foreign Application Priority Data
Mar. 11, 2005 (JP) 2005-068529

(51) Int. Cl. H01J 1/62; H01J 63/04

(52) U.S. Cl. 313/495; 313/497

(57) ABSTRACT

An image display device includes a rear substrate having electron sources, a front substrate having phosphor layers and an anode, and an exhaust tubulation disposed to communicate with a through hole provided in the rear substrate. The image display device is provided with an anode terminal which is embedded in the front substrate with a portion of the anode terminal exposed on an inner surface of the front substrate, and which is electrically coupled to the anode. The image display device is provided with an anode lead-out wire, one end of the anode lead-out wire is coupled to the anode terminal, and another end of the anode lead-out wire is passed through the through hole, and is hermetically sealed with the exhaust tubulation.

### CLAIM OF PRIORITY

The present application claims priority from Japanese application serial no. 2005-068529, filed on Mar. 11, 2005, the content of which is hereby incorporated by reference into this application.

### BACKGROUND OF THE INVENTION

The present invention relates to a flat panel type image display device, and in particular, to an image display device having improved the strength of a structure for introducing a high voltage through a substrate to an internal component.

Conventionally, color cathode ray tubes have been widely used as display devices excellent in producing high-brightness high-definition displays. However, as the image quality in information processing equipment and TV broadcasts has been improved in recent years, the demand has been becoming stronger for flat panel type display devices (also called FPDs) capable of realizing lighter weight and space-saving in addition to the performance of high brightness and high definition. As their typical examples, liquid crystal display devices and plasma display devices have been put to practical use.

Further, various types of flat panel type display devices are under development for practical use. Especially as display devices capable of realizing higher brightness, light-emission type image display devices are being developed which utilize emission of electrons into a vacuum from electron sources. For example, among them are ones called electron-emission type image display devices, and field emission type image display devices. Organic electroluminescent (EL) display devices are also being developed which feature low power consumption.

Among the light-emission type display devices of such flat panel type image display devices, known is one employing a plurality of electron sources arranged in a matrix fashion.

The light-emission type flat panel displays use cold cathodes of the Spindt type, the surface conduction type, the carbon nanotube type, the MIM (Metal-Insulator-Metal) type employing stacked metal, insulator and metal layers, the MIS (Metal-Insulator-Semiconductor) type employing stacked metal, insulator and semiconductor layers, or the electron sources of the metal-insulator-semiconductor-metal type.

As an example of the flat panel type image display devices, a display panel is known which comprises: a rear substrate provided with electron sources such as those explained above; a front substrate disposed to face the rear substrate and provided with phosphor layers and an anode supplied with an accelerating voltage for striking the phosphor layers with electrons emitted from the electron sources; and a support member which serves as a sealing peripheral frame for sealing together the front and rear substrates to obtain a required degree of vacuum in the space between the front and rear substrates. This display panel is operated by using a driver circuit.

An image display device employing electron sources of the MIM type comprises a rear substrate, a front substrate facing the rear substrate and a support member interposed therebetween.

The rear substrate made of an insulating substrate is provided with a large number of first electrodes (for example, cathode electrodes, video signal electrodes) which extend in a first direction and are arranged in a second direction intersecting the first direction, an insulating film covering the first electrodes, a large number of second electrodes (for example, gate electrodes, scanning signal electrodes) disposed to extend in the second direction and to be arranged in the first direction on the insulating film, and electron sources each of which is disposed in the vicinity of a corresponding one of intersections of the first and second electrodes. The scanning signal electrodes are supplied with a scanning signal successively in the second direction. The electron sources are disposed in the vicinity of the respective intersections of the scanning signal electrodes and video signal electrodes on the rear substrate. The electron sources are coupled to corresponding ones of the scanning signal electrodes and video signal electrodes with connector electrodes to supply an electric current to the electron sources.

The front substrate is provided with phosphor layers of plural colors and a third electrode (an anode electrode) on its internal surface facing the rear substrate. The front substrate is made of light-transmissive material, preferably of glass.

The rear and front substrates are sealed together with the support member sandwiched therebetween which serves as a sealing peripheral frame, and then the space enclosed by the rear substrate, the front substrate and the support member is evacuated.

As explained above, the electron sources are disposed in the vicinity of the respective intersections of the first and second electrodes, the amount of electrons emitted from the electron sources, including ON and OFF of electron emission, is controlled based upon a voltage difference between the first and second electrodes. The emitted electrons are accelerated by a high voltage applied to an anode disposed on the front substrate, impinge upon and excite the phosphor layers disposed on the front substrate, and thereby emit light of colors according to emission-color characteristics of the phosphor layers.

Each of the electron sources forms a unit pixel in combination with a corresponding one of the phosphor layers. Usually three unit pixels of three colors, red (R), green (G) and blue (B), respectively, forms one pixel (also referred to as a color pixel). When the technical term ‘color pixel’ is utilized, a unit pixel may be referred to as a subpixel.

As described above, in the flat panel type image display device, generally a plurality of spacing-maintaining members (hereinafter spacers) are arranged and fixed in a display area surrounded by the above-described support member between the front and rear substrates so as to maintain the spacing between the front and rear substrates at a desired value in cooperation with the support member. The spacers are generally plate-like members made of insulating material such as glass and ceramics, and generally each of the spacers is disposed for every plural pixels in a position which does not interfere with operation of the pixels.

The support member which serves as a sealing frame is fixed to peripheral portions of the rear and front substrates with a sealing member such as glass frit to form hermetically sealing regions. The degree of vacuum in the interior of the display region formed by the rear and front substrates and the support member is 10⁻³ to 10⁻⁶ Pa, for example.

First and second lead-out terminals coupled to the first and second electrodes, respectively, disposed on the rear substrate pass through the sealing regions hermetically sealing the support member and the rear and front substrates together. Usually, the support member which serves as the sealing frame are fixed to the rear and front substrates with a sealing member such as glass frit. The first and second lead-out terminals are brought out through the sealing regions hermetically sealing the sealing frame and the rear substrate.

The following will describe other prior art structures for introducing a voltage through a substrate to an internal component.

Japanese Patent Application Laid-Open No. Hei 10-31433 publication (corresponding to U.S. Pat. No. 5,965,978) discloses a field emission type display device employing a connecting means in which one end of an anode lead is pressed against an anode terminal formed on an inner surface of a front panel, and in which the other end of the anode lead is hermetically sealed in and is brought out of a getter room.

Japanese Patent Application Laid-Open No. Hei 10-326581 publication (corresponding to U.S. Pat. No. 6,114,804) discloses an image-forming apparatus in which a high voltage terminal connected to an anode formed on an inner surface of a front panel is hermetically sealed in and is brought out of a rear panel.

Japanese Patent Application Laid-Open No. 2000-260359 (corresponding to U.S. Pat. Nos. 6,476,547; 6,703,779; and 6,954,030) and Japanese Patent Application Laid-Open No. 2003-092075 (corresponding to U.S. Pat. No. 6,885,156) discloses an image-forming apparatus in which one end of an anode lead is connected to an anode terminal of an anode formed on an inner surface of a front panel, and in which the other end of the anode lead is fitted into a rod-shaped insulating member, and is brought out to the outside by being passed through the through hole made in a corner of a rear panel.

Japanese Patent Application Laid-Open No. 2000-311636 (corresponding to U.S. Pat. No. 6,603,255) discloses an image display unit in which one end of an anode lead is connected to an anode terminal of an anode formed on an inner surface of a front panel, and in which the other end of the anode lead is fitted into an insulator, and is brought out to the outside by being passed through the through hole made in a rear panel.

### SUMMARY OF THE INVENTION

The prior art flat panel type image display devices discussed above employ a configuration of introducing a high voltage to a front substrate. Generally, since a front panel serves as a display screen, a high voltage is received on a rear substrate, and then is conducted to an anode formed on the front substrate via a component within the flat panel type image display device from the rear substrate.

As disclosed in the above-cited patents, an example of means for conducting the received high voltage to the anode on the front substrate is such that a tip of an anode lead fixed to the rear substrate is pressed against a thin-film anode deposited on an inner surface of the front substrate. This configuration is advantageous because a spacing between the front and rear substrates of the flat panel type image display devices is selected to be in a range of from several millimeters to some dozen millimeters. There is a problem in that a portion of the thin-film anode in contact with the anode lead disappears due to the deterioration effects of time, therefore it was difficult to secure reliability of electrical connections, resulting in instability of introduction of high voltages, and consequently, there arises a problem with providing flat panel type image display devices capable of a high-quality display and long life time, and there has been a demand for solving the problem.

The present invention has been made so as to solve the above-described problems with the prior art. The present invention is configured such that a conductive anode terminal coupled to the anode is provided on the front substrate, and such that there is provided an anode lead-out wire, one end of which is connected to the anode terminal, and the other end of which is hermetically sealed in and brought out of an exhaust tube. This configuration makes it possible to provide a flat panel type image display devices capable of a high-quality display and long life time by preventing the disappearance of the thin film anode and thereby securing the stable introduction of a high voltage.

The following will explain the summary of the representative ones of the inventions disclosed in this specification.

(1) An image display device comprising: a rear substrate having a plurality of first electrodes extending in a first direction and arranged in a second direction intersecting with said first direction, an insulating film covering said plurality of first electrodes, a plurality of second electrodes extending in said second direction and arranged in said first direction on said insulating film, and a plurality of electron sources, each of said plurality of electron sources being disposed in the vicinity of a corresponding one of intersections of said plurality of first electrodes and said plurality of second electrodes; a front substrate disposed to oppose said rear substrate with a distance therebetween and having phosphor layers of plural colors which generate light by being excited by electrons emitted from said plurality of electron sources, and a third electrode adapted to be supplied with an anode voltage; a support member which is sandwiched between said rear substrate and said front substrate to surround a display region and to maintain said distance; a sealing member which hermetically seals end portions of said support member to said front substrate and said rear substrate, respectively; and an exhaust tubulation disposed to communicate with a through hole provided in said rear substrate, wherein said image display device is provided with an anode terminal which is embedded in said front substrate with a portion of said anode terminal exposed on an inner surface of said front substrate, and which is electrically coupled to said third electrode, and wherein said image display device is provided with an anode lead-out wire, one end of said anode lead-out wire is coupled to said anode terminal, and another end of said anode lead-out wire is passed through said through hole, and is hermetically sealed with said exhaust tubulation.

(2) An image display device according to (1), wherein said anode terminal and said third electrode is electrically coupled together via a conductive thick film.

(3) An image display device according to (1), wherein said anode lead-out wire is detachably engaged with said anode terminal.

(4) An image display device according to (3), wherein said anode terminal is of a shape of a combination of a cup and a lid thereof provided with an opening therein, said anode lead-out wire is provided with a pair of legs comprised of resilient metal, and said anode lead-out wire is detachably engaged with said anode terminal with said pair of legs inserted within said cup via said opening.

(5) An image display device according to (1), wherein a thermal coefficient αa of said anode terminal and a thermal coefficient αg of a glass plate of said front substrate satisfy the following relationship:
0.8×αg≦αa≦1.5×αg

(6) An image display device according to (1), wherein said anode terminal is comprised of an Fe—Ni—Cr alloy.

(7) An image display device according to (1), wherein said anode lead-out wire is comprised of an Fe—Ni—Cr alloy.

(8) An image display device according to (1), wherein a thermal coefficient αw of said anode lead-out wire and a thermal coefficient αe of glass of said exhaust tubulation satisfy the following relationship:
0.8×αe≦αw≦1.5×αe

(9) An image display device according to (1), wherein a wiring structure of said anode lead-out wire hermetically sealed with said exhaust tube is a Dumet wire.

(10) An image display device according to (1), wherein said anode terminal, said through hole and said exhaust tubulation is disposed concentrically with each other with eccentricity equal to or smaller than ±0.5 mm.

(11) An image display device according to (2), wherein said conductive thick film is comprised chiefly of graphite.

(12) An image display device according to (2), wherein said conductive thick film is comprised chiefly of particles of metal or conductive oxides.

(13) An image display device according to (1), wherein a cap-shaped member is fitted over said exhaust tubulation, and an insulating material is filled between said cap-shaped member and said exhaust tubulation.

(14) An image display device according to (13), wherein a cylinder-like member is provided to surround an end portion of said anode lead-out wire projecting from said cap-shaped member, and said end portion of said anode lead-out wire terminates within said cylinder-like member.

(15) An image display device comprising: a rear substrate having a plurality of first electrodes extending in a first direction and arranged in a second direction intersecting with said first direction, an insulating film covering said plurality of first electrodes, a plurality of second electrodes extending in said second direction and arranged in said first direction on said insulating film, and a plurality of electron sources, each of said plurality of electron sources being disposed in the vicinity of a corresponding one of intersections of said plurality of first electrodes and said plurality of second electrodes; a front substrate disposed to oppose said rear substrate with a distance therebetween and having, on an inner surface thereof, a black matrix film provided with a plurality of openings therein, phosphor layers of plural colors which fill said openings, extend beyond said openings on said black matrix, generate light by being excited by electrons emitted from said plurality of electron sources, and light-reflective film which is comprised chiefly of aluminum and which covers said phosphor layers and said black matrix film; a support member which is sandwiched between said rear substrate and said front substrate to surround a display region and to maintain said distance; a sealing member which hermetically seals end portions of said support member to said front substrate and said rear substrate, respectively; and an exhaust tubulation disposed to communicate with a through hole provided in said rear substrate, wherein said image display device is provided with an anode terminal which is embedded in said front substrate with a portion of said anode terminal exposed on an inner surface of said front substrate, wherein said image display device is provided with an anode lead-out wire, one end of said anode lead-out wire is coupled to said anode terminal, and another end of said anode lead-out wire is passed through said through hole, and is hermetically sealed with said exhaust tubulation, and wherein said anode terminal is electrically coupled to said black matrix film and said light-reflective film with a conductive thick film.

The invention recited in (1) provides an image display device capable of a high-quality display and a long lifetime by preventing the disappearance of the thin-film anode and thereby ensuring the stable introduction of a high voltage.

The invention recited in (2) provides an image display device capable of a high-quality display and a long lifetime by securing the reliability of the connection of the anode terminal and the thin-film anode and thereby ensuring the stable introduction of a high voltage.

The invention recited in (3) makes it possible to handle the front substrate as a flat plate in fabrication steps prior to its sealing step and thereby to improving workability.

The invention recited in (4) makes it possible to practice the invention recited in (3) easily.

The invention recited in (5) provides a long lifetime image display device by facilitating of the embedding of the conductive anode terminal, preventing occurrences of distortions in the front glass substrate at the time of embedding the anode terminal, and thereby making it to secure the mechanical strength of the front substrate 2.

The invention recited in (6) makes it possible to practice the invention recited in (1) easily.

The invention recited in (7) makes it possible to practice the invention recited in (1) easily.

The invention recited in (8) makes it possible to hermetically seal the anode lead-out wire at the same time with sealing off the exhaust tubulation, to ensure the fixation of the anode lead-out wire, and thereby to improve workability. This invention simplifies electrical connection to external circuits and ensures the reliability of the electrical connection.

The invention recited in (9) makes it possible to practice the invention recited in (1) easily.

The invention recited in (10) makes it possible to minimize the length of the anode lead-out wire, thereby suppress the occurrences of sparks, and provides a long-lifetime and highly reliable image display device.

The invention recited in (11) provides an image display device capable of a high-quality display and a long lifetime by ensuring the conductive performance and achieving a high degree of vacuum by taking advantage of reduction in the amount of outgassing.

The invention recited in (12) makes it possible to practice the invention recited in (2) easily.

The invention recited in (13) provides a long-lifetime image display device by making it possible to protect the exhaust tubulation and to improve the mechanical strength of the final product.

The invention recited in (14) makes it easy to secure the safety against a high voltage by covering the tip of the anode lead-out wire with the cylinder-like member of the cap-shaped member. Since fitting of a high-voltage terminal in the cylinder-like member of the cap-shaped member makes possible the introduction of a high voltage, it is easy to secure the safety against a high voltage.

The invention recited in (15) provides an image display device capable of a high-quality display and a long lifetime because the anode voltage can be applied uniformly over the entire display region.

### BRIEF DESCRIPTION OF THE DRAWINGS

In the accompanying drawings, in which like reference numerals designate similar components throughout the figures, and in which:

FIGS. 1(a) and 1(b) are illustrations for explaining an embodiment of the image display device in accordance with the present invention, FIG. 1(a) being a plan view of the image display device viewed from its front-substrate side, and FIG. 1(b) being a side view of the image display device of FIG. 1(a);

FIG. 2 is a schematic plan view of the rear substrate of the image display device of FIG. 1(a) with its front substrate removed;

FIG. 3 is a schematic cross-sectional view of the an image display device of FIG. 1(a) taken along line III-III of FIG. 1(a);

FIG. 4 is a schematic cross-sectional view of the rear substrate of FIG. 2 and a corresponding portion of the front substrate of FIG. 1(a) taken along line IV-IV in FIG. 2;

FIG. 5 is an enlarged schematic plan view of a portion of the front substrate of FIG. 3 viewed from the rear-substrate side;

FIG. 6(a) is a schematic cross-sectional view of the image display device taken along line VI-VI of FIG. 5;

FIG. 6(b) is a front view of an example of an anode lead-out wire in accordance with present invention;

FIG. 6(c) is a side view of the example of an anode lead- out wire of FIG. 6(b);

FIG. 6(d) is a front view of another example of an anode lead-out wire in accordance with present invention;

FIG. 7(a) is a schematic cross-sectional view of a portion including an exhaust tubulation in another embodiment of the image display device in accordance with the present invention;

FIG. 7(b) is a schematic cross-sectional view of a portion including an exhaust tubulation in a modification of the embodiment shown in FIG. 7(a) of the image display device in accordance with the present invention;

FIG. 8(a) is a plan view for explaining an example of electron sources constituting pixels in the image display device in accordance with the present invention;

FIG. 8(b) is a cross-sectional view of the electron source of FIG. 8(a) taken along line VIII(b)-VIII(b) in FIG. 8(a);

FIG. 8(c) is a cross-sectional view of the electron source of FIG. 8(a) taken along line VIII(c)-VIII(c) in FIG. 8(a); and

FIG. 9 is an illustration of an example of an equivalent circuit of the image display device in accordance with the present invention.

### DETAILED DESCRIPTION OF THE PREFERRED EMBODIMENTS

In the following the embodiments of the present invention will be explained in detail by reference to the drawings.

### Embodiment 1

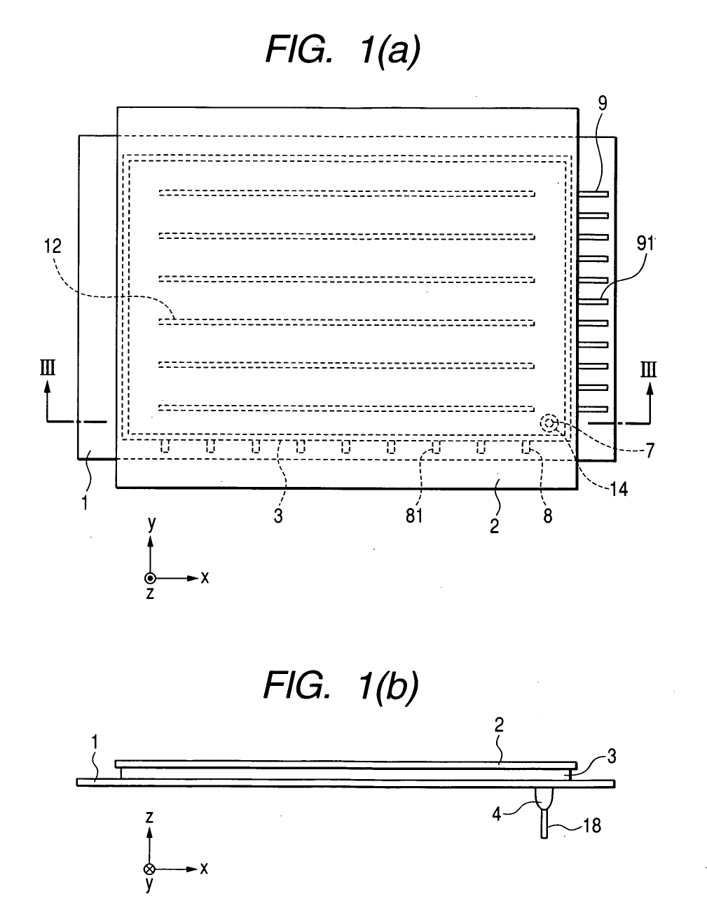

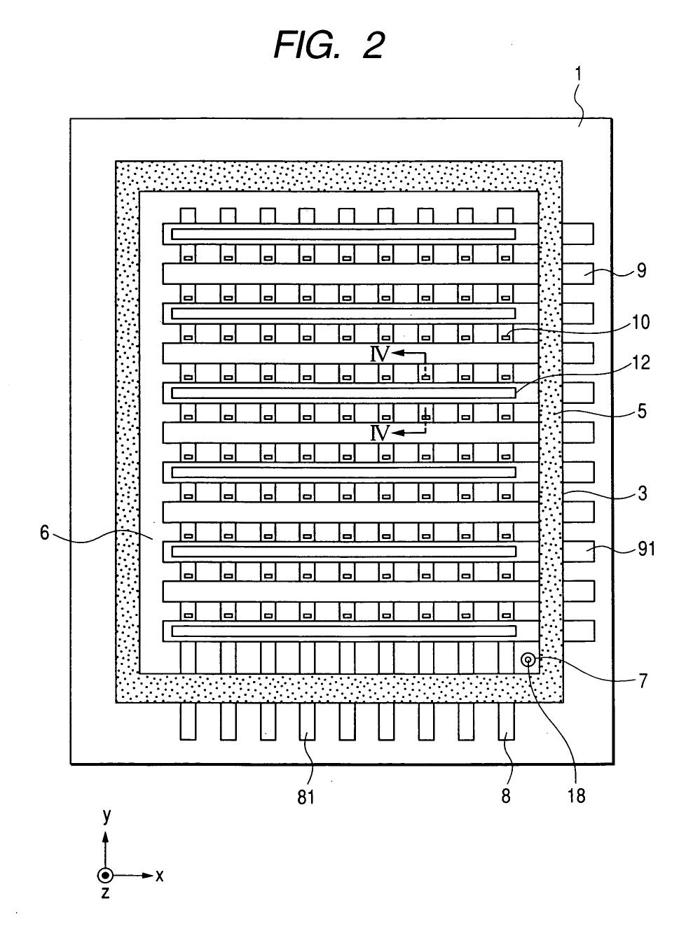

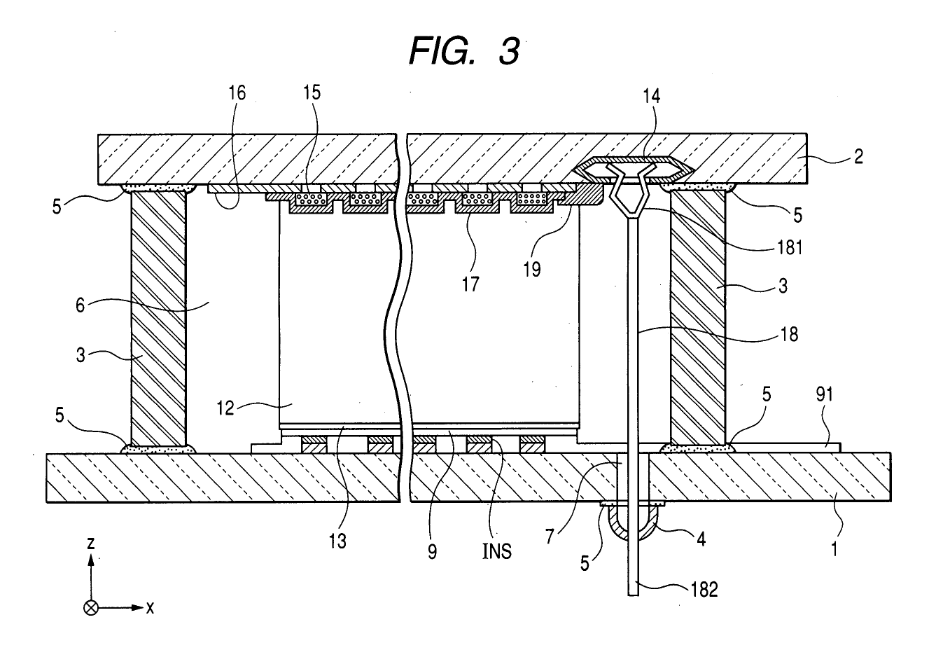

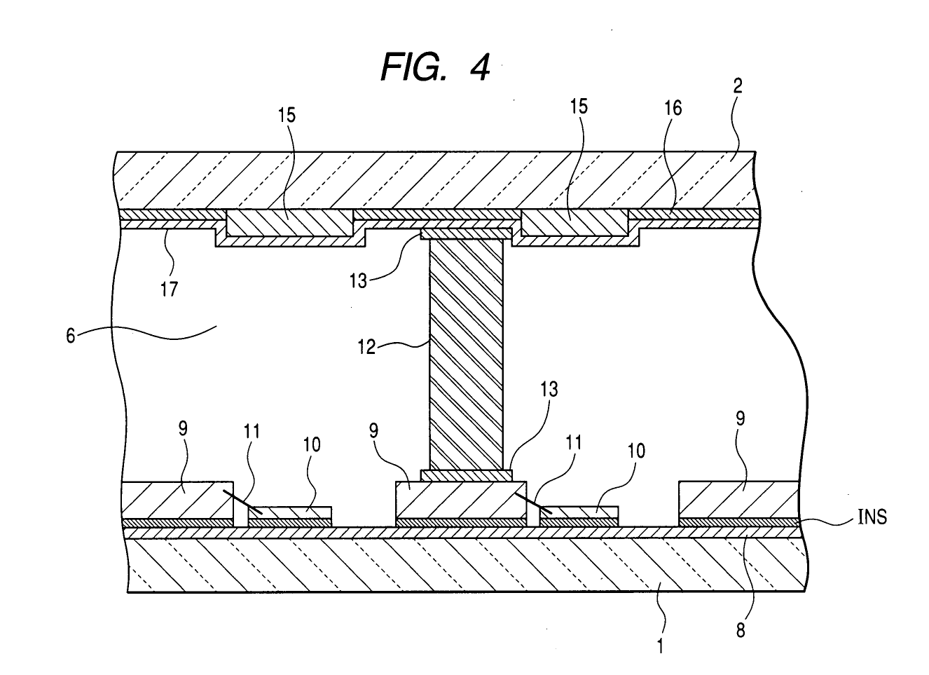

FIGS. 1(a) to FIG. 4 illustrate an embodiment of the image display device in accordance with the present invention. FIG. 1(a) is a plan view of the image display device viewed from its front-substrate side, FIG. 1(b) is a side view of the image display device of FIG. 1(a), FIG. 2 is a schematic plan view of a rear substrate of the image display device of FIG. 1 with its front substrate removed, FIG. 3 is a schematic cross-sectional view of the image display device of FIG. 1 taken along line III-III in FIG. 1, and FIG. 4 is a schematic cross-sectional view of the rear substrate of FIG. 2 taken along line IV-IV in FIG. 2 and a schematic cross-sectional view of a corresponding portion of the front substrate of FIG. 1(a) taken along line IV-IV in FIG. 2.

In FIGS. 1(a) to 3, reference numerals 1 and 2 denote the rear and front substrates, respectively, which are made of glass plates of several millimeters, for example about 3 mm, in thickness. Reference numeral 3 denotes a support member, which is made of a glass plate or a sintered glass frit of several millimeters, for example about 3 mm, in thickness. Reference numeral 4 denotes an exhaust tubulation, which is fixed to the rear substrate 1. The support member 3 is sandwiched between the rear and front substrates 1, 2 along their peripheries, and it is hermetically sealed to the rear and front substrates 1, 2 via a sealing member 5 (see FIG. 2) such as glass frit. The rear and front substrates 1, 2 are aligned coaxially in a direction of superposition (the z direction).

A space enclosed by the support member 3, the rear and front substrates 1, 2 and the sealing member 5 is evacuated via the exhaust tubulation 4, and is maintained at a vacuum in a range of from 10⁻³ to 10⁻⁶ Pa, for example, to provide a display area 6 (see FIG. 2).

The exhaust tubulation 4 is attached to an outer surface of the rear substrate 1 as described above and communicates with a through hole 7 pierced approximately coaxially with the exhaust tubulation 4 in the rear substrate 1, and the exhaust tubulation 4 is sealed off after completion of the evacuation.

Reference numeral 8 denotes video signal lines, which extend in a Y direction and are arranged in an X direction on an inner surface of the rear substrate 1 as shown in FIG. 2. Each of the video signal electrodes 8 has a video signal electrode lead-out terminal 81 at its end portion, and a tip of the video signal electrode lead-out terminal 81 is hermetically sealed between the support member 3 and the rear substrate 1, and thereafter extends to the end portion of the rear substrate 1.

Reference numeral 9 denotes scanning signal lines, which are disposed above the video signal lines 8, extend in the X direction intersecting the video signal lines 8 and are arranged in the Y direction. Each of the scanning signal electrodes 9 has a scanning signal electrode lead-out terminal 91 at its end portion, and a tip of the scanning signal electrode lead-out terminal 91 is hermetically sealed between the support member 3 and the rear substrate 1, and thereafter extends to the end portion of the rear substrate 1.

The through hole 7 is disposed to ensure a distance of at least 3 mm from the video signal electrodes 8 and the scanning signal electrodes 9. There is a fear of occurrence of variations in dimensions of the electrodes 8, 9 if the distance is selected to be smaller than 3 mm.

Reference numeral 10 denotes electron sources. Each of the electron sources 10 is disposed in the vicinity of a corresponding one of intersections of the scanning signal electrodes 9 and the video signal electrodes 8, and is coupled to the scanning signal electrodes 9 with the connector electrode 11. Further, an interlayer insulating film INS is disposed between the video signal electrodes 8 and the scanning signal electrodes 9. The video signal electrodes 8 are comprised of an Al/Nd film, for example, and the scanning signal electrodes 9 is comprised of an Ir/Pt/Au film, for example.

Reference numeral 12 denotes spacers. The spacers 12 are comprised of a ceramic material, and are shaped into rectangular thin plates. In this embodiment the spacers 12 are disposed to stand upright on every second one of the scanning signal lines 9, and are fixed to the rear substrate 1 and the front substrate 2 with an adhesive member 13. Usually the spacers 12 are disposed in positions of every plural pixels where the spacers 12 do not interfere with operation of pixels. The dimensions of the spacers 12 are determined based upon the dimensions of the rear and front substrates 1, 2, the height of the support member 3, the material of the rear and front substrates 1, 2, the intervals of arrangement of the spacers 12, the material of the spacers 12 and others. Generally, from a practical point of view, the dimensions of the spacers 12 are selected as follows: the height is approximately equal to that of the support member 3, the thickness is in a range of from several tens of microns to several millimeters, the length is in a range of from 20 mm to 200 mm, preferably in a range of from 80 mm to 120 mm. The spacers 12 have a specific resistance in a range of from about 10⁸ Ωcm to about 10⁹ Ωcm.

In FIG. 3, reference numeral 14 denotes a cup-shaped anode terminal. The cup-shaped anode terminal 14 is comprised of an Fe—Ni—Cr alloy comprising 40-49% of Ni, 2-6% of Cr, and the balance of Fe, for example, and is embedded at a below-explained position on an inner surface on a rear-substrate-1 side of the front substrate 2. The cup-shaped anode terminal 14 is embedded in the front substrate 2 approximately concentrically with the exhaust tubulation 4 which is disposed near the support member 3 on the rear substrate 1 within the display region 6 such that the exhaust tubulation 4 does not interfere with a regular displaying operation when the rear substrate 1 and the front substrate 2 are superposed one upon another concentrically with each other in the z direction. The cup-shaped anode terminal 14 may be embedded in the front substrate 2 by initially wrapping a glass layer around a portion of a body of the cup-shaped anode terminal 14, and thereafter embedding the cup-shaped anode terminal 14 in the front substrate 2 such that a portion of the cup-shaped anode terminal 14 on its opening side is exposed toward the inner surface of the rear substrate 1. The above-described embedding of the cup-shaped anode terminal 14 is performed at a glass plate level of the front substrate 2, and then the front substrate 2 is subjected to required fabrication steps after being subjected to pretreatments such as washing.

Disposed on the inner surface of the front substrate 2 with the cup-shaped anode terminal 14 embedded therein are phosphor layers 15 partitioned into red phosphor portions, green phosphor portions and blue phosphor portions with a light-blocking black matrix (BM) film 16, and a metal back (an anode electrode) 17 made of a metal thin film is formed by using an evaporation method to cover the phosphor layers 15, thereby completing a phosphor screen.

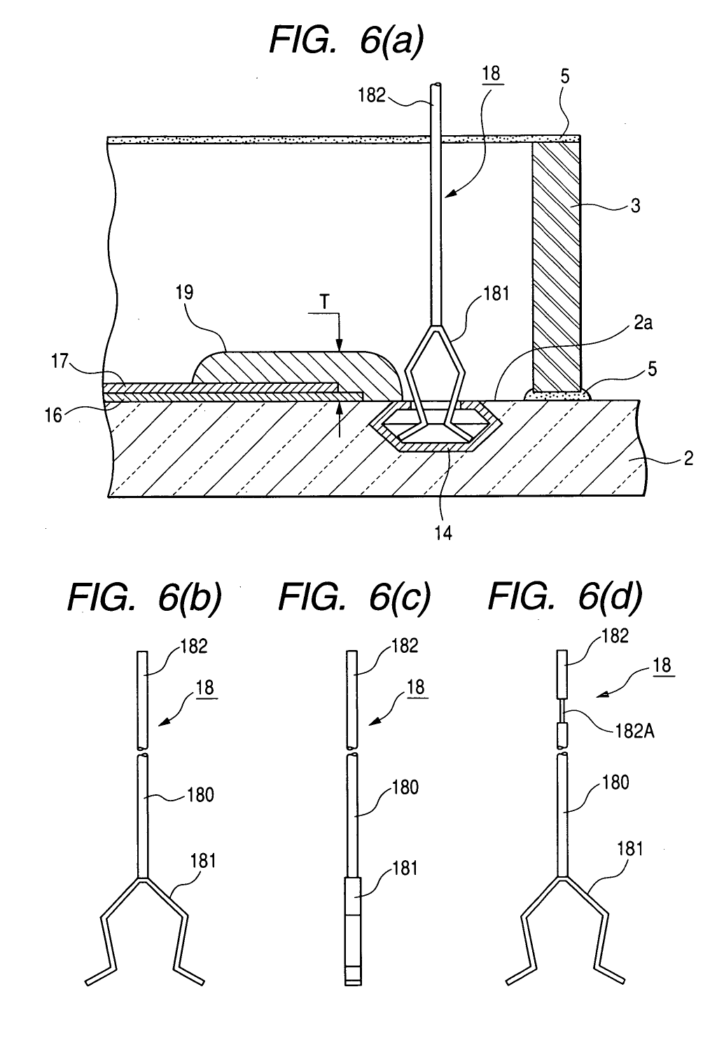

Reference numeral 18 denotes an anode lead-out wire, whose front view is shown in FIG. 6(b), and whose side view is shown in FIG. 6(c). A body portion 180 of the anode lead-out wire 18 is formed of a metal wire comprised of an Fe—Ni—Cr alloy, for example, and of about 0.8 mm to about 1.1 mm in diameter, for example. Joined to the body portion 180 as by welding is a first end portion 181 which is comprised of a resilient metal, for example, an Inconel (trademark) alloy of approximately 80 percent nickel, 14 percent chromium, and 6 percent iron, and which is formed by shaping the metal plate of about 1 mm in width into the shape of a fork.

The anode lead-out wire 18 is detachably engaged with the cup-shaped anode terminal 14 via the first end portion 181 of the anode lead-out wire 18. A second end portion 182 of the anode lead-out wire 18 extends approximately in parallel with the height direction of the support member 3 toward the rear substrate 1, then passes through the through hole 7, and then is brought out to the outside after being hermetically sealed with exhaust tubulation 4.

The anode lead-out wire 18 has a spring-attachment configuration in which initially the first end portion 181 is inserted into the cup-shaped anode terminal 14 by being compressed and deformed, and thereafter is released to be decompressed to ensure complete contact of the anode lead-out wire 18 with the cup-shaped anode terminal 14 by actuating the resilient first end portion 181. The spring-attachment configuration is required to have performance of withstanding a heat treatment at about 450° C., for example, and retaining the resiliency. The second end portion 182 of the anode lead-out wire 18 is passed through the through hole 7 is hermetically sealed in the exhaust tubulation 4 at the same time with sealing off the exhaust tubulation 4 made of glass after evacuation.

Further, in a case where the thermal coefficient of expansion of the material of the body portion 180 of the anode lead-out wire 18 does not match that of the glass of the exhaust tubulation 4, a wiring structure 182A comprised of material having the thermal coefficient of expansion approximately matching that of the exhaust tubulation 4, for example, a Dumet wire, may be provided at the second end portion 182 of the anode lead-out wire 18, and may be hermetically sealed in the exhaust tubulation 4 at the same time with sealing off the exhaust tubulation 4 made of glass after evacuation.

The following will discuss a relationship between the thermal coefficient of expansion of the cup-shaped anode terminal 14 and the anode lead-out wire 18 and that of glass to be hermetically sealed with them. Take soda-lime glass as sealing glass, for example. Its thermal coefficient of expansion is 87×10⁻⁷/° C. (50-350° C.). Thermal coefficients of expansion of Fe-48Ni-2Cr alloy, Fe-42Ni-6Cr alloy, and Fe-47Ni-6Cr alloy, usable for the cup-shaped anode terminal 14 and the anode lead-out wire 18, are 83×10⁻⁷/° C. (30-450° C.), 105×10⁻⁷/° C. (30-350° C.), and 110×10⁻⁷/° C. (30-350° C.), respectively. The thermal coefficient of expansion of the Dumet wire is said to be approximately 55-65×10⁻⁷/° C. (40-350° C.). Therefore it may be desirable that the thermal coefficient αa of expansion of the cup-shaped anode terminal 14 and the thermal coefficient αg of expansion of the glass substrate sealing the anode terminal 14 therein satisfy the following relationship:
0.8×αg≦αa≦1.5×αg.

Further, it maybe desirable that the thermal coefficient αw of expansion of the anode lead-out wire 18 and the thermal coefficient αe of expansion of the glass exhaust tubulation 4 sealing the anode lead-out wire 18 therein satisfy the following relationship:
0.8×αe≦αw≦1.5×αe.

Reference numeral 19 denotes a thick conductive film for electrical connection. The thick conductive film 19 is coated between the light-blocking black matrix (BM) film 16 and the metal back 17, and the cup-shaped anode terminal 14 on the phosphor screen to electrically connect the cup-shaped anode terminal 14 to the BM film 16 and the metal back 17. The thick conductive film 19 is formed by using a paste composed chiefly of graphite, for example, and its thickness is selected to be in a range of from several microns to twenty-odd microns so that the thickness is enough to ensure reliability in electrical connection. The details will be described later.

As phosphor materials for the phosphor layers 15, by way of example, Y₂O₂S:Eu (JEDEC phosphor type P22-R) may be used for red color, ZnS:Cu, Al (JEDEC phosphor type P22-G) may be used for green color, and ZnS:Ag, Cl (JEDEC phosphor type P22-B) may be used for blue color.

With this phosphor screen configuration, electrons emitted from the electron sources 10 are accelerated to impinge upon a portion of the phosphor layers 15 constituting an intended pixel, thereby the portion of the phosphor layers 15 generates light of a desired color, which is combined with the emission color of phosphors of other pixels to form a color pixel of a desired color. Although the metal back 17 is illustrated as unstructured, the metal back 17 may be made in the form of stripes intersecting the scanning signal lines 9, each of which stripes corresponds to one of columns of pixels.

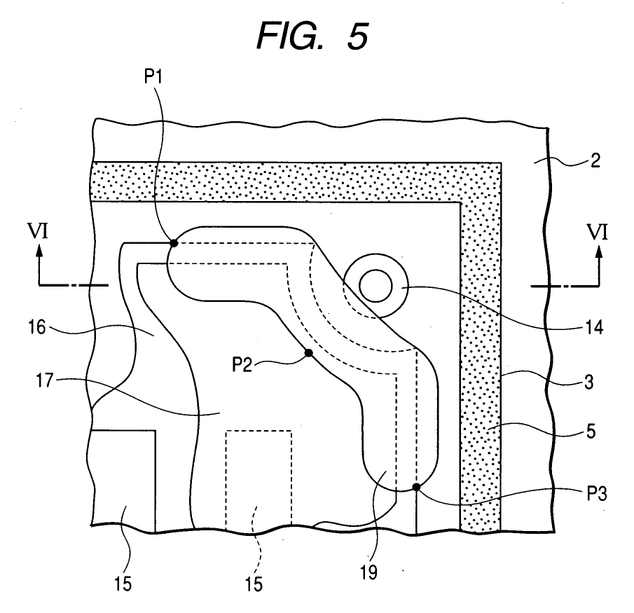

FIGS. 5 and 6(a) are enlarged views of portions of the image display device of this embodiment of the present invention shown in FIG. 3, FIG. 5 is a schematic plan view of the image display device viewed from the rear-substrate-1 side, and FIG. 6(a) is a cross-sectional view of the image display device of FIG. 5 taken along line VI-VI in FIG. 5. The same reference numerals as utilized in previous FIGURES designate corresponding or functionally similar portions in FIGS. 5 and 6(a).

In FIGS. 5 and 6(a), the cup-shaped anode terminal 14 is disposed proximately to a corner of the support member 3 on the rear substrate 1 and approximately concentrically with the through hole 7 (not shown) made in the rear substrate 1. The cup-shaped anode terminal 14 is embedded in the front substrate 2 such that its opening-containing surface is approximately flush with an inner surface 2a of the front substrate 2. The opening-containing surface of the cup-shaped anode terminal 14 is electrically connected to the BM film 16 and the metal back 17 with the thick conductive film 19. The thick conductive film 19 may be formed by coating a graphite paste using a brush, for example. As explained above, the thickness T of the thick conductive film 19 needs to be in a range of from several microns to twenty-odd microns, and is practically selected to be approximately in a range of from 5 microns to 15 microns. The length of coating of the thick conductive film 19 is defined as the length of contact of the thick conductive film 19 with the BM film 16 and the metal back 17, that is, in FIG. 5, the distance from a first contact point P1 of the film 19 with the BM film 16, passing through a second contact point P2 of the film 19 with the metal back 17 at an inner location, to a third contact point P3 of the film 19 with the BM film 16. The above-defined length of contact of the thick conductive film 19 with the BM film 16 and the metal back 17 may be selected to be in a range of from several centimeters to several tens of centimeters, and is practically in a range of from 5 cm to 15 cm. Pastes used for forming the thick conductive film 19 may include metal particles of Pt, Au, Ag, Rh, Ir, Al, Sb, Sn, Pb, Zn, In, Cu, Ni, Co, Fe, Mn, Cr, V, Ti, Zr, Nb, Mo, or W, or particles of conductive oxides such as ITO, ATO, or ZnO, in addition to the above-described graphite paste.

By electrically connecting the anode terminal 14 embedded in the front substrate 2 to the BM film 16 and the metal back 17 using the thick conductive film 19, the configuration of Embodiment 1 makes it possible to secure reliability of the structure for introducing a high voltage through a substrate to an internal component, resulting instable high-voltage introduction, and consequently, provides a flat panel type image display device capable of a high-quality display and long life time.

Further, when the anode lead-out wire 18 is configured to be detachably engaged with the anode terminal 14, this configuration improves workability in fabrication of image display devices, and also reduces the number of times when the anode lead-out wire 18 is subjected to heat treatments.

Further, the arrangement of the anode terminal 14 approximately concentric with the exhaust tubulation 4 can minimize the length of the anode lead-out wire 18, thereby suppress occurrences of sparks, and can provide a long-life-time, highly reliable image display device. To ensure satisfactory advantages of the concentric arrangement, it is preferable to dispose the anode terminal 14, the through hole 7 and the exhaust tubulation 4 with eccentricity equal to or smaller than +0.5 mm.

### Embodiment 2

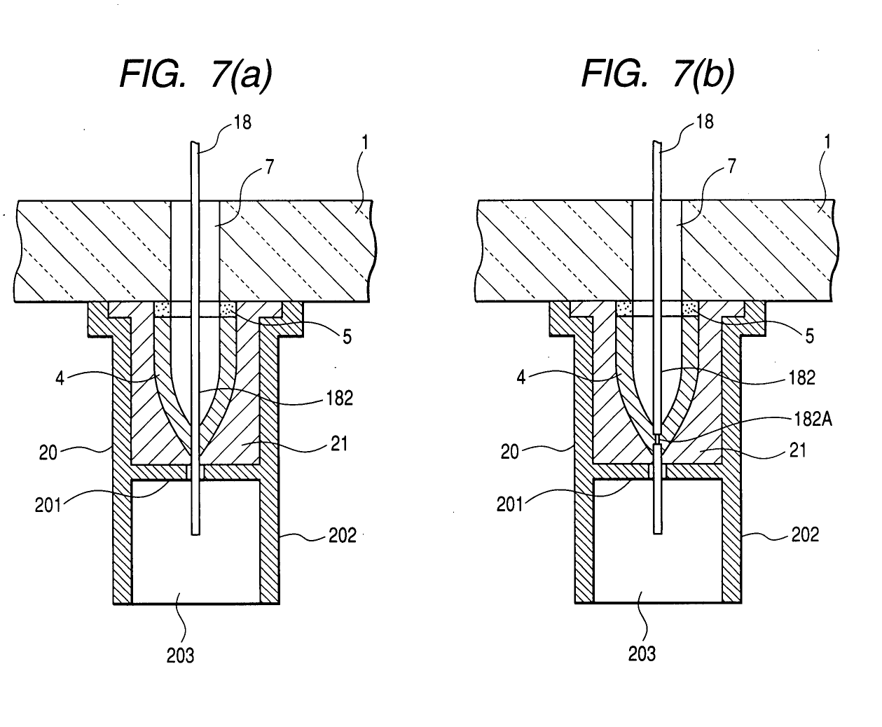

FIG. 7(a) is a schematic cross-sectional view of a portion in the vicinity of the exhaust tubulation of another embodiment of the image display device in accordance with the present invention, and the same reference numerals as utilized in the previous figures designate corresponding portions in FIG. 7(a). In FIG. 7(a), the exhaust tubulation 4 is fixed to the rear substrate 1 concentrically with the through hole 7, and hermetically seals the anode lead-out wire 18 extending from the anode terminal 14 and passing through the through hole 7. A cap-shaped member 20 comprised of an insulating material, polycarbonate, for example, is fitted over the exhaust tubulation 4, and an insulating member 21 is filled into a space between the cap-shaped member 20 and the exhaust tubulation 4. Further, the cap-shaped member 20 is provided with a cylinder-like portion 202 extending downward from a closing end 201 of the cap-shaped member 20 in FIG. 7(a), and the cylinder-like portion 202 surrounds a tip portion of the second end portion 182 of the anode lead-out wire 18 projecting from the closing end 201 of the cap-shaped member 20. The length of the cylinder-like portion 202 is selected such that the tip portion of the second end portion 182 of the anode lead-out wire 18 terminates within the cylinder-like portion 202. A high voltage is introduced via an opening 203 of the cylinder-like portion 202.

The configuration of Embodiment 2 makes it possible to protect the exhaust tubulation 4, and also to improve the mechanical strength of a final product, and therefore provides a long lifetime image display device.

Further, this embodiment is capable of facilitating the introduction of a high voltage, and preventing leakage due to a high voltage, and therefore provides a high-quality long-lifetime image display device.

Incidentally, although Embodiment 1 is configured such that the anode lead-out wire 18 is detachably engaged with the anode terminal 14, Embodiment 1 may be modified such that the anode lead-out wire 18 is permanently fixed to the anode terminal 14 as by welding. Further, although Embodiment 1 is configured such that the anode terminal 14 is disposed approximately concentrically with the exhaust tubulation 4, Embodiment 1 may be modified such that the anode terminal 14 is not concentric with the exhaust tubulation 4.

Further, FIG. 7(b) illustrates a case where Embodiment 2 is applied to the above-explained case where a wiring structure 182A comprised of material having the thermal coefficient of expansion approximately matching that of the exhaust tubulation 4, for example, a Dumet wire, is provided at the second end portion 182 of the anode lead-out wire 18, and is hermetically sealed in the exhaust tubulation 4.

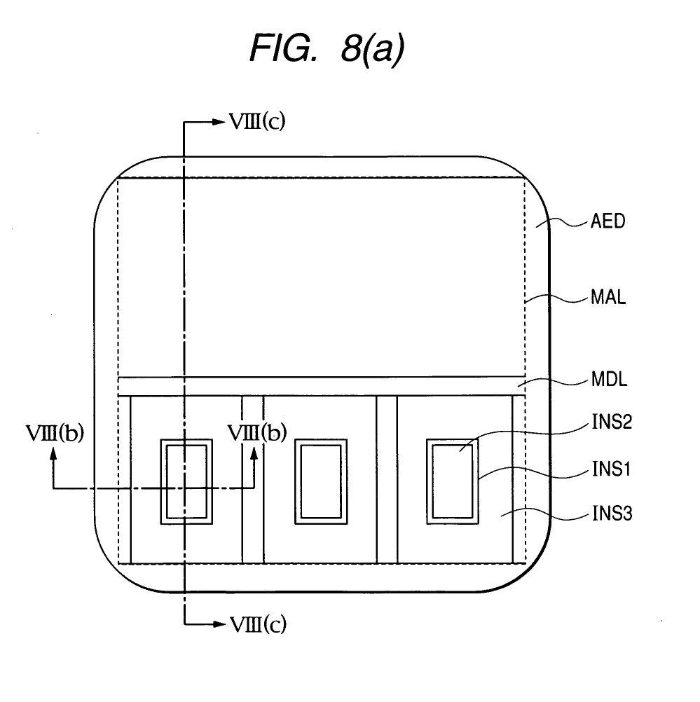

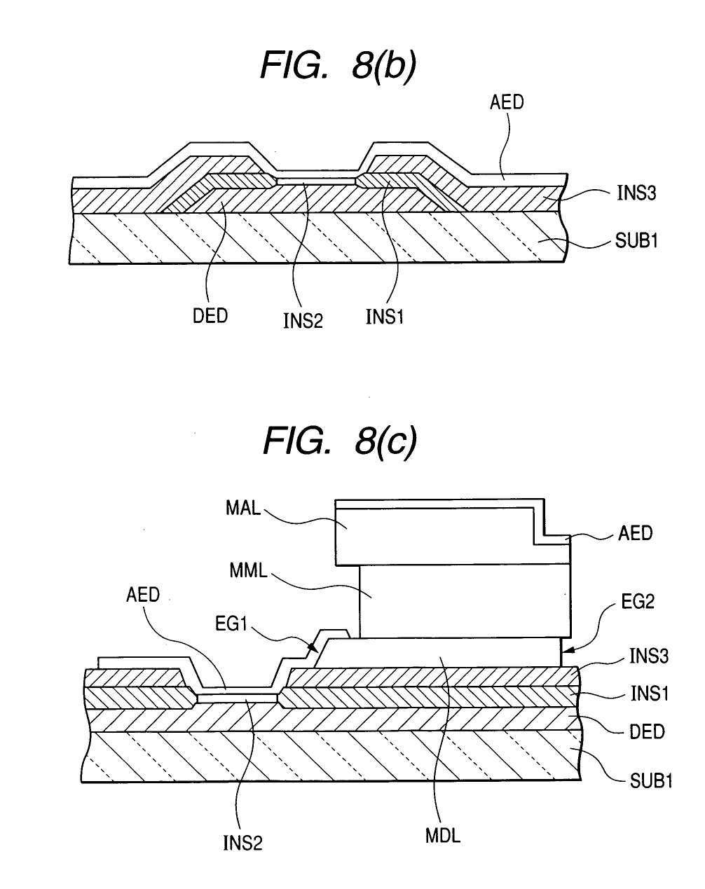

Next, FIGS. 8(a) to 8(c) are illustrations for explaining an example of electron sources constituting pixels in the image display device in accordance with the present invention, FIG. 8(a) is a plan view of the electron sources, FIG. 8(b) is a cross-sectional view of the electron source of FIG. 8(a) taken along line VIII(b)-VIII(b) in FIG. 8(a), and FIG. 8(c) is a cross-sectional view of the electron source of FIG. 8(a) taken along line VIII(c)-VIII(c) in FIG. 8(a). The electron source in this case is of the MIM (Metal-Insulator-Metal) type.

The configuration of the electron source will be explained in connection with its fabrication steps.

First, fabricated on the rear substrate 1 are a lower electrode DED (which corresponds to the video signal electrodes 8 in the previous embodiments), a protective insulating layer INS1, and an insulating layer INS2.

Next, an interlayer film INS3 is formed, and thereafter formed as by sputtering are an upper bus electrode (which corresponds to the scanning signal electrodes 9 in the previous embodiments) which serves as a feeding line to an upper electrode AED, and a metal film which serves as a spacer electrode for disposing a spacer 12. Aluminum can be used for the lower electrode DED and the upper electrode AED, and other metals can be used as explained later. The interlayer film INS3 can be made of silicon oxide, silicon nitride or silicon, for example. Here the interlayer film INS3 is made of a silicon nitride film of 100 nm in thickness. The interlayer film INS3 fills pinholes possible in the protective insulating layer INS1 fabricated by using anodic oxidation, and thereby serves to ensure insulation between the lower electrode DED and the upper bus electrode which serves as a scanning signal electrode and which is a three-layer film comprised of a metal film lower-layer MDL, a metal film upper-layer MAL and a metal film intermediate-layer MML of Cu sandwiched between the lower- and upper-layers MDL, MAL.

Incidentally, the number of layers in the upper bus electrode is not limited to three, and may be four or more. For example, the metal film lower-layer MDL and the metal film upper-layer MAL may be comprised of aluminum (Al), and metal materials having high resistance to oxidation, such as chromium (Cr), tungsten (W), molybdenum (Mo), or alloys containing those metal materials, or stacked films of those metal materials.

Here an Al—Nd alloy comprised of aluminum and neodymium was used for the metal film lower-layer MDL and the metal film upper-layer MAL. Further, when a five-layer film comprised of an aluminum alloy and Cr, W or Mo is for the metal film lower-layer MDL, a stacked film comprised of an aluminum alloy and Cr, W or Mo is for the metal film upper-layer MAL, and films made of refractory metal in contact with the metal film intermediate-layer MML of Cu, the films made of refractory metal serve as barrier films and suppresses alloying of Al and Cu in heat treatments in the fabrication process of the image display device, and this configuration is useful especially for reducing the wiring resistances.

In a case where only the Al—Nd alloy is used for the metal film lower-layer MDL and the metal film upper-layer MAL, the thickness of the film comprised of the Al—Nd alloy for the metal film upper-layer MAL is selected to be greater than that for the metal film lower-layer MDL, and the thickness of the metal film intermediate-layer MML of Cu is selected to be as great as possible so as to reduce the wiring resistances. Here the metal film lower-layer MDL was selected to be 300 nm in thickness, the metal film intermediate-layer MML was selected to be 4 μm in thickness, and the metal film upper-layer MAL is selected to be 450 nm. Incidentally, the metal film intermediate-layer MML of Cu may be fabricated as by electroplating, instead of sputtering.

In a case where the above-described five-layer film including the refractory metal is employed, it is particularly useful to utilize a stacked film in which Cu is sandwiched by Mo to which wet etching is applicable in a mixed aqueous solution of phosphoric acid, acetic acid and nitric acid as in the case of Cu, as the metal film intermediate-layer MML. In this case, the thickness of the Mo films sandwiching the Cu film is selected to be 50 nm, and the thicknesses of the aluminum alloy films of the metal film lower-layer MDL and the metal film upper-layer MAL sandwiching the metal film intermediate-layer MML are selected to be 300 nm and 450 nm, respectively.

Next, the metal film upper-layer MAL is shaped into the form of a line intersecting the lower electrode DED by screen-printing a resist pattern and an etching process. This etching process employs wet etching using a mixed aqueous solution of phosphoric acid and acetic acid, for example. This makes possible to selectively etch the Al—Nd alloy only without etching Cu by not adding nitric acid to the etching solution.

Also in the case of the five-layer film containing Mo, it is possible to selectively etch the Al—Nd alloy only without etching Mo and Cu by not adding nitric acid to the etching solution.

In the above example, the metal film upper-layer MAL is shaped into the form of one line for each of the pixels, and it may be shaped into the form of two lines for each of the pixels.

Next, Cu contained in the metal film intermediate-layer MML is subjected to wet etching in a mixed aqueous solution of phosphoric acid, acetic acid and nitric acid, for example, by using, as a mask, the resist film used in the preceding process step or the Al—Nd alloy film of the metal film upper-layer MAL. Since the etching rate of Cu is sufficiently higher than that of the Al—Nd alloy in a mixed aqueous solution of phosphoric acid, acetic acid and nitric acid, only Cu of the metal film intermediate-layer MML can be selectively etched. In the case of the five-layer film containing Mo, the etching rate of Mo and Cu is sufficiently higher than that of the Al—Nd alloy, and therefore only three-layer film containing Mo and Cu can be etched selectively. A aqueous solution of ammonium persulfate or sodium persulfate is also useful for etching of Cu.

Next, the metal film lower-layer MDL is shaped into the form of a line intersecting the lower electrode DED by screen-printing a resist pattern and an etching process. This etching process employs wet etching using a mixed aqueous solution of phosphoric acid and acetic acid. Here the resist film is printed such that it is displaced from the position of the stripe electrode of the metal film upper-layer MAL, and an end EG1 on one side of the metal film lower-layer MDL projects from the metal film upper-layer MAL. The end EG1 will be used as a contact portion for securing contact of the metal film lower-layer MDL with the upper electrode AED in a later processing step. Another end EG2 on a side opposite from the end EG1 of the metal film lower-layer MDL is subject to over etching by using the metal film upper-layer MAL and the metal film intermediate-layer MML as a mask such that the metal film lower-layer MDL recedes and the metal film intermediate-layer MML forms eaves. The eaves of the metal film intermediate-layer MML divides the upper electrode AED fabricated in a later processing step. Here, since the thickness of the metal film upper-layer MAL is selected to be greater than that of the metal film lower-layer MDL, the metal film upper-layer MAL can be left on the Cu of the metal film intermediate-layer MML even after the etching of the metal film lower-layer MDL is finished. Since this configuration can protect the surface of Cu, even when Cu is utilized, it can provide the upper bus electrode which serves as a scanning signal lines for supplying a signal, and which has resistance to acid and divides the upper electrode AED in a self-aligning fashion. In the case of the metal film intermediate-layer MML comprised of the five-layer film in which Cu is sandwiched between Mo films, even when the thickness of the Al alloy of the metal film upper-layer MAL, since Mo suppresses oxidation of Cu, it is not always necessary to select the thickness of the metal film upper-layer. MAL to be greater than that of the metal film lower-layer MDL.

Next, an opening is made at a position in the interlayer insulating film INS3 corresponding to an electron emitting portion. The electron emitting portion is disposed at a portion of an intersection of one of the lower electrodes DED and a region sandwiched between two of the upper bus electrodes (one stacked film comprised of the metal film lower-layer MDL, the metal film intermediate-layer MML, the metal film upper-layer MAL for one pixel, and another stacked film comprised of the metal film lower-layer MDL, the metal film intermediate-layer MML, the metal film upper-layer MAL for another pixel adjacent to the one pixel). The opening in the interlayer insulating film INS3 is made by using dry etching using an etching gas comprised chiefly of CF₄ or SF₆, for example.

Finally, the film of the upper electrode AED is fabricated by sputtering. The upper electrode AED may be made of Al, or a stacked film made of iridium (Ir), platinum (Pt) and gold (Au). The thickness of the upper electrode AED may be selected to be 6 nm, for example. Here, at one end (on the right-hand side of FIG. 8(c)) of the upper bus electrode (the stacked film of the metal film lower-layer MDL, the metal film intermediate-layer MML and the metal film upper-layer MAL), the upper electrode AED is cut off by the receding portion (EG2) of the metal film lower-layer MDL due to the structure of the eaves formed by the metal film intermediate-layer MML and the metal film upper-layer MAL, and at the end (on the left-hand side of FIG. 8(c)) of the upper bus electrode, the upper electrode AED is electrically connected to the upper bus electrode (the stacked film of the metal film lower-layer MDL, the metal film intermediate-layer MML and the metal film upper-layer MAL) via the contact portion EG1 of the metal film lower-layer MDL, thereby providing an electrical supply path to the electron emitting portion.

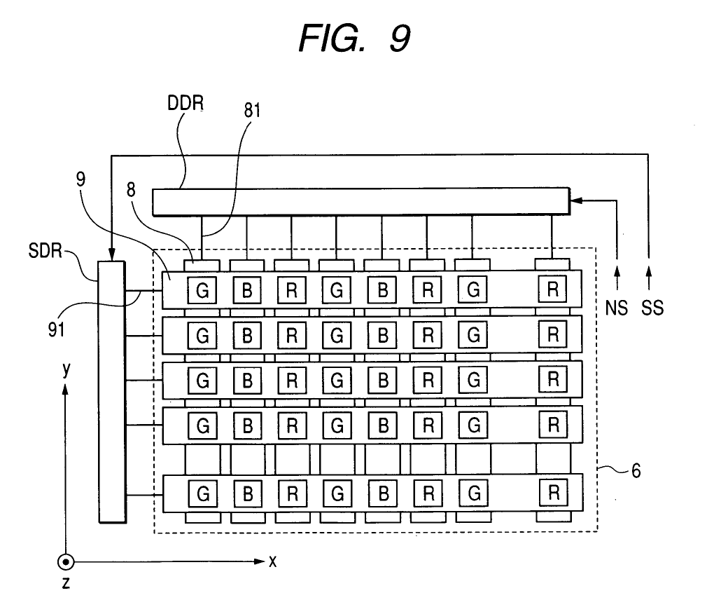

FIG. 9 is an illustration of an example of an equivalent circuit of the image display device to which the present invention is applied.

A region indicated by broken lines in FIG. 9 is a display region 6. Formed in the display region 6 is a matrix of n×m which is formed by n video signal electrodes 8 and m scanning signal electrodes 9 arranged to intersect with each other in the display region 6. One unit pixel is disposed at each of the intersections of the matrix. A group comprising three unit pixels (sub-pixels) of R (red), G (green) and B (blue) in FIG. 9 form one pixel. Incidentally, the configuration of the electron sources is omitted from FIG. 9. The video signal electrodes (cathode electrodes) 8 are coupled to a video signal driver circuit DDR via video signal lead-out terminals 81, and the scanning signal electrodes (gate electrodes) 9 are coupled to the scanning signal driver circuit SDR via scanning signal electrode lead-out terminals 91. The video signal driver circuit DDR is supplied with video signal NS from an external signal source, and the scanning signal driver circuit SDR is supplied with a scanning signal SS in the same way. With this configuration, a full-color two-dimensional display is produced by supplying appropriate video signals to pixels associated with successively selected scanning signal electrodes 9. The above described configuration of the display panel realizes an image display device featuring high efficiency at a comparatively low voltage.

What is claimed is:

1. An image display device comprising:
a rear substrate having a plurality of first electrodes extending in a first direction and arranged in a second direction intersecting with said first direction, an insulating film covering said plurality of first electrodes, a plurality of second electrodes extending in said second direction and arranged in said first direction on said insulating film, and a plurality of electron sources, each of said plurality of electron sources being disposed in the vicinity of a corresponding one of intersections of said plurality of first electrodes and said plurality of second electrodes;
a front substrate disposed to oppose said rear substrate with a distance therebetween and having phosphor layers of plural colors which generate light by being excited by electrons emitted from said plurality of electron sources, and a third electrode adapted to be supplied with an anode voltage;
a support member which is sandwiched between said rear substrate and said front substrate to surround a display region and to maintain said distance;
a sealing member which hermetically seals end portions of said support member to said front substrate and said rear substrate, respectively; and
an exhaust tubulation disposed to communicate with a through hole provided in said rear substrate,
wherein said image display device is provided with an anode terminal which is embedded in said front substrate with a portion of said anode terminal exposed on an inner surface of said front substrate, and which is electrically coupled to said third electrode, and
wherein said image display device is provided with an anode lead-out wire, one end of said anode lead-out wire is coupled to said anode terminal, and another end of said anode lead-out wire is passed through said through hole, and is hermetically sealed with said exhaust tubulation.

2. An image display device according to claim 1, wherein said anode terminal and said third electrode is electrically coupled together via a conductive thick film.

3. An image display device according to claim 1, wherein said anode lead-out wire is detachably engaged with said anode terminal.

4. An image display device according to claim 3, wherein said anode terminal is of a shape of a combination of a cup and a lid thereof provided with an opening therein, said anode lead-out wire is provided with a pair of legs comprised of resilient metal, and said anode lead-out wire is detachably engaged with said anode terminal with said pair of legs inserted within said cup via said opening.

5. An image display device according to claim 1, wherein a thermal coefficient αa of said anode terminal and a thermal coefficient αg of a glass plate of said front substrate satisfy the following relationship:
0.8×αg≦αa≦1.5×αg

6. An image display device according to claim 1, wherein said anode terminal is comprised of an Fe—Ni—Cr alloy.

7. An image display device according to claim 1, wherein said anode lead-out wire is comprised of an Fe—Ni—Cr alloy.

8. An image display device according to claim 1, wherein a thermal coefficient αw of said anode lead-out wire and a thermal coefficient αe of glass of said exhaust tubulation satisfy the following relationship:
0.8×αe≦αw≦1.5×αe

9. An image display device according to claim 1, wherein a wiring structure of said anode lead-out wire hermetically sealed with said exhaust tube is a Dumet wire.

10. An image display device according to claim 1, wherein said anode terminal, said through hole and said exhaust tubulation is disposed concentrically with each other with eccentricity equal to or smaller than ±0.5 mm.

11. An image display device according to claim 2, wherein said conductive thick film is comprised chiefly of graphite.

12. An image display device according to claim 2, wherein said conductive thick film is comprised chiefly of particles of metal or conductive oxides.

13. An image display device according to claim 1, wherein a cap-shaped member is fitted over said exhaust tubulation, and an insulating material is filled between said cap-shaped member and said exhaust tubulation.

14. An image display device according to claim 13, wherein a cylinder-like member is provided to surround an end portion of said anode lead-out wire projecting from said cap-shaped member, and said end portion of said anode lead-out wire terminates within said cylinder-like member.

15. An image display device comprising:
a rear substrate having a plurality of first electrodes extending in a first direction and arranged in a second direction intersecting with said first direction, an insulating film covering said plurality of first electrodes, a plurality of second electrodes extending in said second direction and arranged in said first direction on said insulating film, and a plurality of electron sources, each of said plurality of electron sources being disposed in the vicinity of a corresponding one of intersections of said plurality of first electrodes and said plurality of second electrodes;
a front substrate disposed to oppose said rear substrate with a distance therebetween and having, on an inner surface thereof, a black matrix film provided with a plurality of openings therein, phosphor layers of plural colors which fill said openings, extend beyond said openings on said black matrix, generate light by being excited by electrons emitted from said plurality of electron sources, and
a light-reflective film which is comprised chiefly of aluminum and which covers said phosphor layers and said black matrix film;
a support member which is sandwiched between said rear substrate and said front substrate to surround a display region and to maintain said distance;
a sealing member which hermetically seals end portions of said support member to said front substrate and said rear substrate, respectively; and
an exhaust tubulation disposed to communicate with a through hole provided in said rear substrate,
wherein said image display device is provided with an anode terminal which is embedded in said front substrate with a portion of said anode terminal exposed on an inner surface of said front substrate,
wherein said image display device is provided with an anode lead-out wire, one end of said anode lead-out wire is coupled to said anode terminal, and another end of said anode lead-out wire is passed through said through hole, and is hermetically sealed with said exhaust tubulation, and
wherein said anode terminal is electrically coupled to said black matrix film and said light-reflective film with a conductive thick film.
